(19) United States
(12) Patent Application Publication
(10) Pub. No.: US 2006/0059504 A1
(43) Pub. Date: Mar. 16, 2006

(54) Method for selecting a preview of a media work

(76) Inventors: Eduardo Gomez, Miami Beach, FL (US); Ricardo Gomez, Miami Beach, FL (US); Jeffrey M. Schox, San Francisco, CA (US)

Correspondence Address: Jeffrey Schox, Esq., #200, 209 N. Main Street, Ann Arbor, MI, 48104, US

(21) Appl. No.: 11/013,030

(22) Filed: Dec. 14, 2004

Related U.S. Application Data
(63) Continuation-in-part of application No. 10/941,686, filed on Sep. 14, 2004.

(51) Int. Cl. H04N 7/16; H04N 7/173

(52) U.S. Cl. 725/8; 725/86; 725/87

(57) ABSTRACT

In an embodiment of the invention, the method includes: providing metadata for a media work including a first entry that corresponds to a first preview of the media work and a second entry that corresponds to a second preview of the media work; accepting a first input from a user; selecting for the user a preview of the media work amongst the first preview and the second preview based on the first user input and the metadata; and transmitting the selected preview to the user.

### CROSS-REFERENCE TO RELATED APPLICATIONS

This application is a continuation-in-part of prior application Ser. No. 10/941,686 filed 14 Sep. 2004 and entitled “A Method for Capturing a Media Segment”, which is incorporated in its entirety by this reference.

### TECHNICAL FIELD

This invention relates generally to the field of media works, and more specifically to a new and useful method for selecting a preview of a media work for a user.

### BACKGROUND

As the price of broadband Internet access decreases, media works (such as moving pictures and songs) are becoming easier to purchase and download over the Internet. Because of this ease, many users have access to very large collections of media works. These large collections, however, have brought new challenges. Finding a desirable media work to experience has become a difficult problem for users. With limited time and patience, many users desire a method to quickly search and browse through thousands of media works.

One way to solve this problem would be to present trailers of the media works to the users, as described in U.S. Pat. No. 5,945,987 entitled “Interactive Entertainment Network System and Method for Providing Short Sets of Preview Video Trailers”, which is incorporated in its entirety by this reference. A trailer for a media work, by design, is only a small portion of the work. This small portion of the work may persuade certain users to download or purchase the work, but may have little effect on other users. These other users maybe otherwise enticed, if shown another preview that better matched their interests, to download and/or purchase the media work.

Thus, there is a need in the field of media works to create a new and useful method to select for a user an effective preview of a media work amongst multiple previews. This invention provides such method.

### BRIEF DESCRIPTION OF THE FIGURES

FIGS. 1 and 2 are schematic representations of the program and system that use variations of the first method of the invention;

FIG. 3 is a schematic representation of the relationship between a media work, content data of the media work, a media segment, and segment parameters for the media segment;

FIGS. 4 and 5 are schematic representations of the program and system that use additional variations of the first method of the invention;

FIG. 6 is a schematic representation of the relationship between a media work and a first preview and a second preview of the media work;

FIG. 7 is a schematic representation of the metadata for the media work and the previews of the media work; and

FIGS. 8 and 9 are schematic representations of the program and system that use variations of the fourth method of the invention.

### DESCRIPTION OF THE PREFERRED EMBODIMENTS

The following description of embodiments and multiple variations of the invention is not intended to limit the invention to these embodiments and variations, but rather to enable any person skilled in the art to make and use this invention.

1. A Method for Capturing a Media Segment

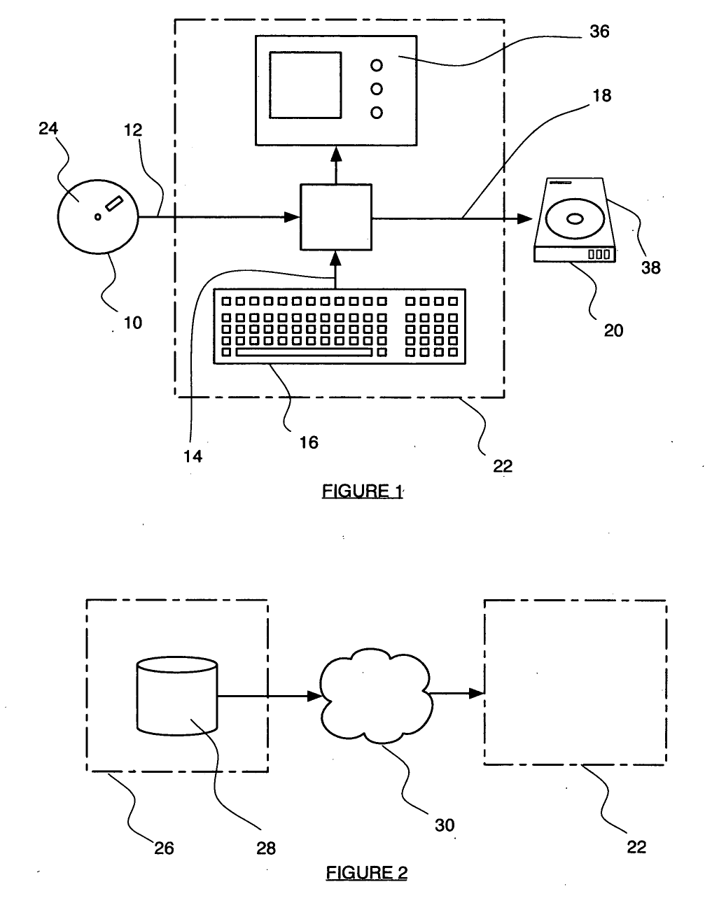

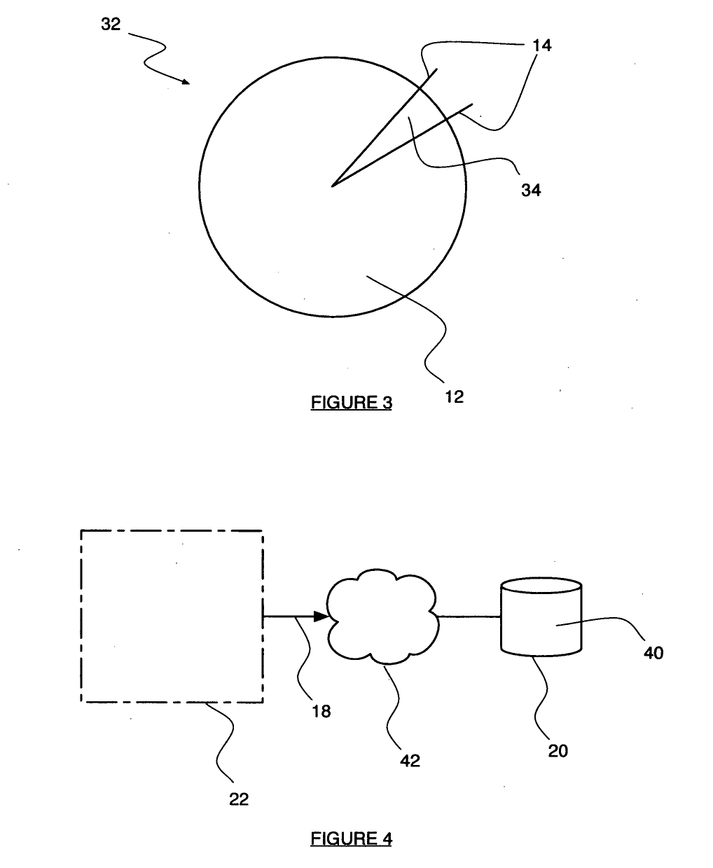

As shown in FIGS. 1 and 2, the method of a first embodiment of the invention includes: from a first source 10, receiving content data 12 corresponding to a media work; receiving segment parameters 14 from an input device 16; deriving data corresponding to a media segment of the media work based on the segment parameters 14; and sending the derived data 18 to a second source 20. The steps of the method are preferably performed by a program on a network connected to a suitable device or system 22, such as a computer (e.g., a PDA, a laptop, or a desktop), a radio frequency communication device (e.g., a cellular phone), or an entertainment device (e.g., an MP3 player, a home entertainment system, or a portable gaming device). The method may, however, alternatively be performed by any suitable combination of hardware, firmware, software, and other devices and systems.

The first source 10 preferably facilitates communication of the media work to the user. In a first variation (of FIG. 1), the first source 10 is a media storage device 24, such as a DVD, CD, mini-disk, hard-drive, magnetic tape, vinyl record, flash drive, or any other suitable device that can at least temporary store a moving picture, a song, an image, or a story. In this variation, the first source 10 is preferably directly connected (either with or without wires) to the device or system 22 of the user. In a second variation (of FIG. 2), the first source 10 is a media provider 26, such as a movie distributor, a television broadcaster, or any other suitable provider of media works. In this variation, the media provider 24 may communicate the media work from a network server 28 to a user through a suitable medium 30, such as radio frequency waves, the Internet, a satellite system, a cable network, a landline or wireless telephone network, or any other suitable medium. In alternative variations, the first source 10 is any suitable system that facilitates communication of the media work to the device or system 22 of the user.

As shown in FIG. 3, the media work 32 is preferably a moving picture, a song, an image, or another media-rich work having a relatively large amount of digital data. By “relatively large amount of digital data”, we mean any amount that is time-consuming to download via the Internet. Within this document, we intend “moving pictures” to include all audio-video works (such as movies, television shows, and video games), we intend “song” to include all audio works (such as radio shows and speeches), and we intend “image” to include all two dimensional works (such as photographs and drawings). The media work 32 may alternatively be a “story” or another media-light work having a relatively small amount of digital data. Within this document, we intend “story” to include all text works (such as novels and blog entries). The media work 32, however, may alternatively be any suitable work.

The content data 12 of the media work 32 preferably allows communication of the media work 32. For example, if the media work 32 is a moving picture, the content data 12 preferably includes audio-video information in any suitable format (such as mpg). If the media work 32 is a song, the content data 12 preferably includes audio information in any suitable format (such as .mp3). If the media work 32 is an image, the content data 12 preferably includes raster or bit-map information in any suitable format (such as .jpg). If the media work 32 is a story, the content data 12 preferably includes text information in any suitable format (such as .txt). The content data 12, however, may alternatively include any suitable information that allows communication of the media work 32.

The media segment 34 is preferably a relatively small and generally continuous segment of the media work 32, such as a 30-second scene of a moving picture, a lyric or riff in a song, a particular object or layer within an image, or paragraph or quote from a story. Alternatively, the media segment 34 may be of any size and may, in certain cases, be discontinuous. The media segment 34 is preferably, however, not a segment of the media work 32 that is already captured within the media work 32. For example, the media segment 34 is preferably neither an entire chapter of a movie on a DVD, nor an entire track of an album on a CD.

The segment parameters 14 preferably allow a user to identify a particular media segment of the media work. The segment parameters 14 may include time parameters (such as time-in and time-out) when the content data 12 includes audio-video information or when the content data 12 includes audio information. The segment parameters 14 may alternatively include coordinates or layer information when the content data 12 includes raster or bit map information, or word or page number information when the content data 12 includes text information. The segment parameters 14 may, however, alternatively include any suitable information that allows a user to identify a media segment of the media work.

As shown in FIGS. 1 and 2, the input device 16 preferably facilitates selection of the media segment by a user. The input device 16 preferably includes a mouse, keyboard, microphone, any other suitable device, or any combination of any permutation of suitable devices. Alternatively, the input device 16 may include any suitable device that facilitates selection of the media segment by a user.

Preferably, the method of the first embodiment further includes sending at least a portion of the media work to an output device 36. This step preferably occurs between receiving the content data 12 corresponding to the media work and receiving segment parameters 14 from an input device 16. The step may, however, occur at any suitable time or position. By sending at least a portion of the media work to the output device 36, the user is able to experience the media work and more intelligently select a particular media segment of the media work. The output device 36 preferably facilitates an experience of the media work by the user. The output device 36 preferably includes a monitor, a speaker, a tactile device, any other suitable device, or any suitable combination of any permutation of suitable devices. Further, the output device 36 is preferably directly connected (either with or without wires) to the device or system 22 of the user. Alternatively, the output device 36 may include any suitable device that facilitates an experience of the media work by the user and may be connected in any suitable manner to the device or system 22 of the user.

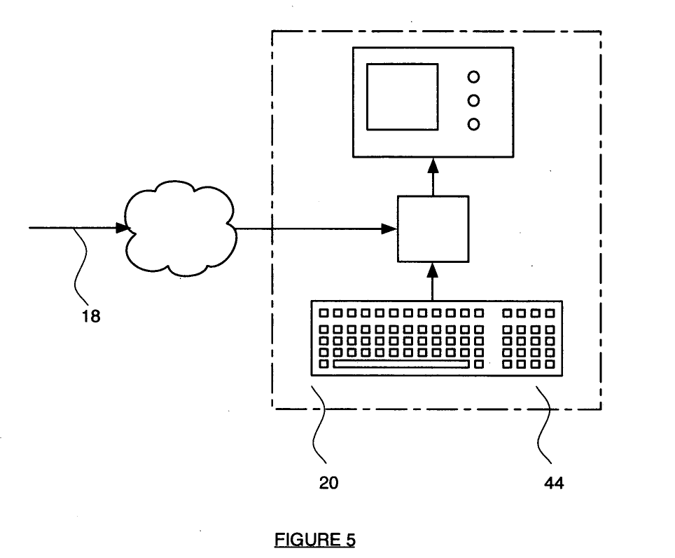

The second source 20 preferably facilitates storage of the derived data 18 for later retrieval by the same user or by other users. In a first variation, the second source 20 is a data storage device 38, such as a DVD-R, CD-R, mini-disk, hard-drive, magnetic tape, flash drive, or any other suitable device that can at least temporary store the derived data 18. In a second variation, as shown in FIG. 4, the second source 20 is a network server 40. In this variation, the user may communicate the derived data 18 to the network server through a suitable medium 42, such as radio frequency waves, the Internet, a satellite system, a cable network, a landline or wireless telephone network, or any other suitable medium. In a third variation, a shown in FIG. 5, the user may communicate the derived data 18 to a peer device 44. The peer device 44 may be a computer (such as a PDA, a laptop, or a desktop), a radio frequency communication device (such as a cellular phone), or an entertainment device (such as an MP3 player, a home entertainment system, or a portable gaming device). In this variation, a payment for these services could be required. Payment could be made by authentication as a member, authentication as a subscriber, direct payment, or some other combination or permutation of similar techniques. In alternative variations, the second source 20 is any suitable system that facilitates storage of the derived data 18 for later retrieval and use by the same user or by other users.

In a second embodiment, the method includes the steps of the first embodiment with a modification to the step of receiving segment parameters 14 from an input device 16 and a corresponding modification to the step of deriving data.

In the second embodiment, the step of receiving segment parameters 14 also includes receiving other information, such as segment theme, keywords, mini-segment parameters, and output device type. In a first variation, the step includes receiving a segment theme from the input device 16. The segment theme preferably represents the subject matter or user's perception of the media segment. For example, the user may input “classic 80's scenes” for the “Bueller? Bueller? Bueller?” scene in the movie “Ferris Bueller's Day Off”, or may input “killer guitar riff” for the opening portion of the song “Whole Lotta Love” by Led Zeppelin. These segment themes may be provided as an inclusive list to the user, or may be entered by the user. In a second variation, the step includes receiving keywords from the input device 16. The keywords preferably represent the actors, authors, or artists featured in the media segment. Following the above examples, the user may input “Ben Stein” or “Jimmy Page.” Alternatively, the actor, author, and artist information may be retrieved from a suitable database, such as www.imdb.com, and a suitable list may be presented to the user. In a third variation, the step of receiving input parameters includes receiving mini-segment parameters 14 from the input device 16. The mini-segment parameters 14 preferably aid in the identification of the media segment. Following the above examples, the user may select just the audio portion of the line “Bueller? Bueller? Bueller?” to aide in the identification of that particular scene, or may select just the first five notes of “Whole Lotta Love” to represent that particular opening portion. In a fourth variation, the step of receiving input parameters includes receiving an output device type from the input device 16. The output device type preferably represents the current type of output device 36 for the user. For example, the output device 36 type may include “HDTV monitor”, “small mobile phone screen”, “high definition speakers” or any other description of the type of output device 36 for the user. The step of receiving input parameters may, of course, include receiving a combination of the segment theme, the keywords, the mini-segment parameters, and the output device type, or may include any other suitable permutation of these inputs or other inputs.

In the second embodiment, the step of deriving data preferably includes deriving meta data corresponding to the media segment of the media work. The meta data preferably includes information to identify the media work and the media segment, but preferably does not include the actual content data of the media segment. Consequently, the meta data is preferably based on a work identification and the segment parameters 14. The meta data may, however, be alternatively based on any suitable information to identify the media work and the media segment. Further, the meta data may alternatively include additional information, such as the segment theme, the keywords, the mini-segment parameters, the input device type, or any combination or permutation of suitable parameters and information.

In a third embodiment, the method includes the steps of the first embodiment with an alternative modification to the step of deriving data. In the this embodiment, the step of deriving data preferably does not include deriving meta data for the media segment, but rather includes deriving content data corresponding to the media segment of the media work based on the segment parameters 14. The content data preferably facilitates communication and reproduction of the media segment without any reference to the content data 12 of the media work. Consequently, the content data of the media segment is preferably based on the content data 12 of the media work and on the segment parameters 14. The content data may, however, be alternatively based on any suitable information to facilitate communication and reproduction of the media segment. Further, the content data may alternatively include additional information, such as the segment theme, the mini-segment parameters, the input device type, or any combination or permutation of suitable parameters and information.

Preferably, the derivation of the content data in the third embodiment also includes a format conversion. The content data 12 for the media work is preferably coded in a first format (such as DV or MPEG-4 for audio-video works) that is generally used in home theater systems (which typically include a receiver and 5+ speakers). This format, however, is not optimized for bandwidth-limited communications, such as communications through radio frequency waves, the Internet, or a landline or wireless telephone network. Thus, the content data for the media segment is preferably converted and/or compressed to a second format (such as .swf or .mp3) that is generally used in a computer system on a network (such as the Internet).

2. A Method for Selecting a Preview of a Media Work

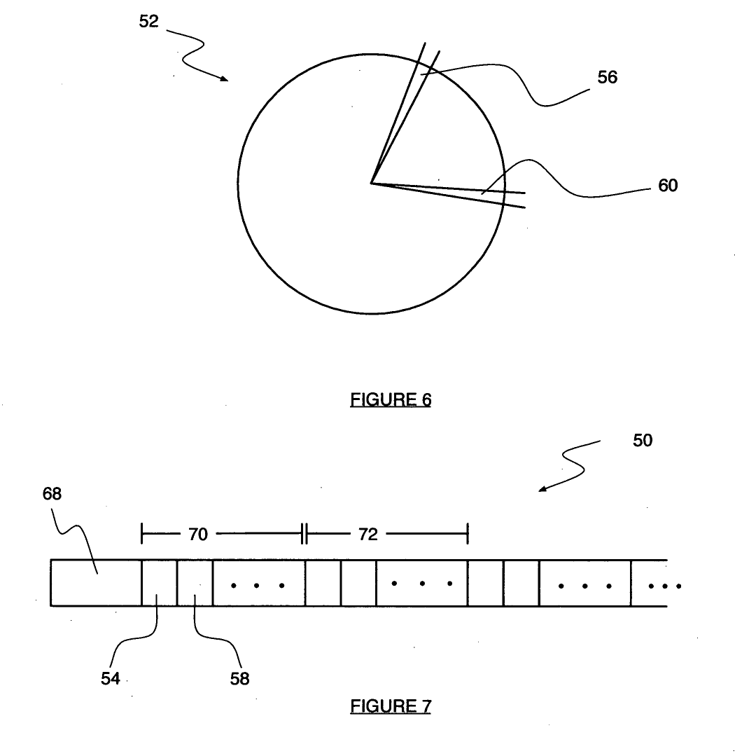

As shown in FIGS. 6-9, the method of a fourth embodiment of the invention includes: providing metadata 50 for a media work 52 including a first entry 54 that corresponds to a first preview 56 of the media work 52 and a second entry 58 that corresponds to a second preview 60 of the media work 52; accepting a first input 62 from a user; selecting for the user a preview of the media work 52 amongst the first preview 56 and the second preview 60 based on the first user input 62 and the metadata 50; and transmitting the selected preview 64 to the user. The steps of the method are preferably performed by a program on a network connected to a suitable device or system 66, such as a computer (e.g., a PDA, a laptop, or a desktop), a radio frequency communication device (e.g., a cellular phone), or an entertainment device (e.g., an MP3 player, a home entertainment system, or a portable gaming device). The method may, however, alternatively be performed by any suitable combination of hardware, firmware, software, and other devices and systems.

As shown in FIG. 6, the media work 52 is preferably a moving picture, a song, or another media-rich work having a relatively large amount of digital data. By “relatively large amount of digital data”, we mean any amount that is time-consuming to download via the Internet. Within this document, we intend “moving pictures” to include all audio-video works (such as movies, television shows, video games, and multimedia performances), and we intend “song” to include all audio and musical works (such as symphony performances, radio shows, and speeches). The media work 52 may alternatively be a “story” or another media-light work having a relatively small amount of digital data. Within this document, we intend “story” to include all text works (such as novels and blog entries). The media work 52, however, may alternatively be any suitable work.

The first preview 56 and the second preview 60 of the media work 52 preferably include a portion of the media work 52. In a first variation, the previews 56 and 60 are a relatively small and generally continuous segment of the media work 52, such as a 30-second scene of a moving picture, a lyric or riff in a song, or paragraph or quote from a story. In a second variation, the previews 56 and 60 are a discontinuous, collage-like composition of relatively small and generally continuous segments of the media work 52, such as a 60-second trailer of a moving picture. Alternatively, the previews 56 and 60 may be of any size. The previews 56 and 60 are preferably, however, not a segment of the media work 52 that is already captured within the media work 52. For example, the previews 56 and 60 are preferably neither an entire chapter of a movie on a DVD, nor an entire track of an album on a CD.

As shown in FIG. 7, the metadata 50 preferably includes information about the media work 52 and/or one or more of the previews 56 and 60 of the media work 52, but preferably does not include the actual content data of the media work 52 or the previews 56 and 60. In a first variation (shown in FIG. 7), the metadata 50 includes a first segment 68 with information about the media work 52, a second segment 70 with information about a first media category, and a third segment 72 with information about a second media category. Within the second segment 70 and the third segment 72, the metadata 50 preferably includes a first entry 54 that corresponds to the first preview 56 and a second entry 58 that corresponds to the second preview 60. In a second variation, the metadata 50 includes a segment with information about the first preview 56 and another segment with information about the second preview 60. Within the two segments, the metadata 50 preferably includes a first entry 54 that corresponds to a first media category and a second entry 58 that corresponds to a second media category. In alternative variations, the metadata 50 about the media work 52 and each of the previews of the media work 52 may be grouped or arranged in any suitable manner.

The metadata 50 about the previews 56 and 60 of the media work 52 preferably includes metadata relating to at least one media category, such as actor name, character name, genre, keyword, recording location (such as San Francisco or Memphis), timestamp (such as “opening credits” or “1 hour, 44 minutes, and 20 seconds”), or dialog/lyric content. As an example, consider the moving picture “Ferris Bueller's Day Off” and a first preview 56 that includes a 30-second clip of the “Bueller? Bueller? Bueller?” scene and a second preview 60 that includes a 30-second clip of the 1961 Ferrari 250 GT California used in the moving picture. The metadata 50 for the media work 52 may include a keyword media category. A first entry 54 within the keyword media category may be “school teacher” which would correspond to the first preview 56 with the “Bueller? Bueller? Bueller?” scene, while a second entry 58 with the keyword media category may be “exotic car” which would correspond to the second preview 60 with the “Ferrari” scene.

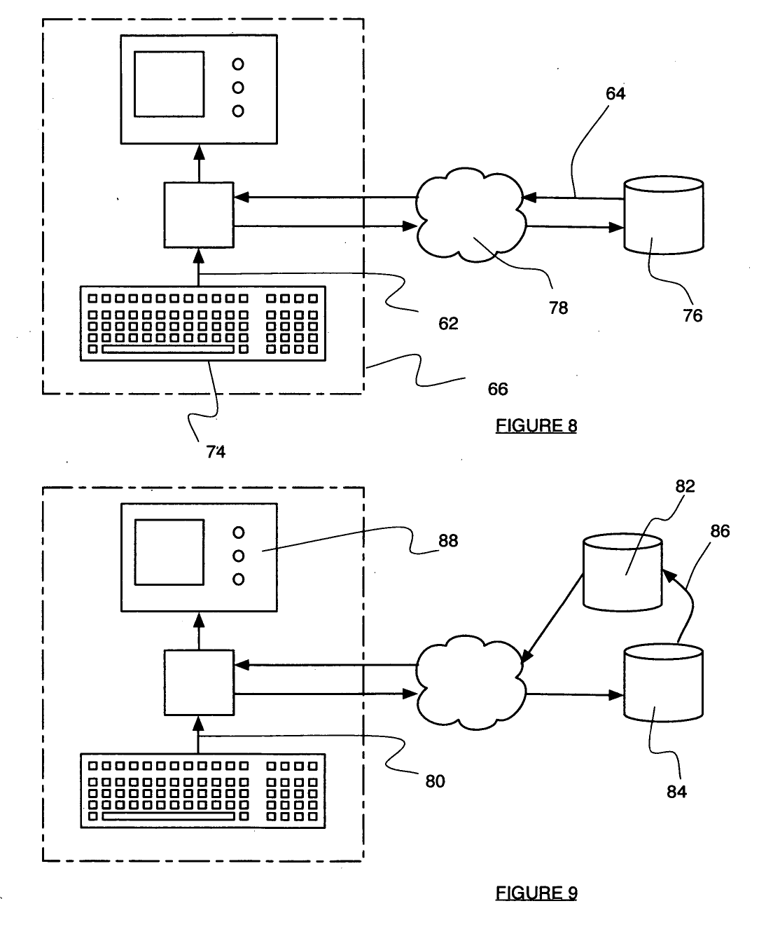

As shown in FIG. 8, the step of accepting a first input 62 from a user preferably functions to facilitate the selection of media works to be presented to the user. In a first variation, the step of accepting a first input 62 from the user includes accepting a first input as a search term for a particular media category within the media works. As an example, the user may be presented with a search interface that allows the user to search amongst the media works by the keyword media category. In a second variation, the step of accepting a first input 62 from the user includes accepting a first input as a search term for all media categories. In further variations, the step of accepting a first input from the user may be accomplished in any suitable manner.

The step of accepting a first input 62 from a user is preferably accomplished through the use of an input device 74. The input device 74 preferably includes a mouse, keyboard, microphone, any other suitable device, or any combination of any permutation of suitable devices. Alternatively, the input device 74 may include any suitable device that facilitates the first input 62 from a user.

The step of selecting an effective preview of the media work 52 amongst the first preview 56 and the second preview 60 functions to entice the selection of the media work 52 amongst thousands of media works. Preferably, this step allows for the display of an effective preview for each media work in the selection of media works that will be presented to the user. The step of selecting an effective preview of the media work 52 is preferably based on the first user input 62 and the metadata 50.

In a first variation, the step of selecting an effective preview of the media work 52 is preferably based on a comparison of the first user input 62 for a media category and the first entry 54 and the second entry 58 within the media category. This comparison is preferably accomplished with a string search algorithm, but may alternatively be accomplished with any suitable algorithm. Following the above example, if a first user input 62 included the phrase “teacher” in the keyword media category, the phrase would be compared with “school teacher” and “exotic car”. The best match, of course, would be with “school teacher”, which would result in a selection of the 30-second clip of the “Bueller? Bueller? Bueller?” scene for the user.

In a second variation, the step of selecting an effective preview of the media work 52 is preferably based on a first user input 62 for a self-profile and the metadata 50. In this variation, a profile for the user may be collected from the user through the use of questionnaires, a rating system (such as the “star rating” system found on the Netflix.com website or the “user rating” system found on the IMDB.com website), or any other suitable methods. As an example, if the user identifies a particular preference for “guitar instrumentals” over “sexually-charged lyrics”, then the effective preview for the song “Whole Lotta Love” by Led Zepplin would be an audio clip of the initial portion of the song with the first five notes, rather than an audio clip of the middle portion of the song with the lyrics “Way, way down inside, I'm gonna give you my love.”

In a third variation, the step of selecting an effective preview of the media work 52 is preferably based on the first user input 62 regarding previous media work 52 selections and the metadata 50. In this variation, the metadata 50 of the media works that the user has downloaded, purchased, emailed, or otherwise identified is compared with the metadata 50 for the first preview 56 and the second preview 60. As an example, if the user has downloaded, purchased, emailed, or otherwise identified a preference for comedy moving pictures (such as “The Wedding Singer” and “Happy Gilmore”) rather than romantic/dramatic moving pictures (such as “Breaking the Waves” and “Hilary and Jackie”), then the effective preview for moving picture “Punch-Drunk Love” would include a 30-second video clip of Adam Sandler purchasing thousands of pudding cups, rather than a 30-second video clip of Adam Sandler kissing Emily Watson.

In a fourth variation, the step of selecting an effective preview of the media work 52 is preferably based on any suitable information derived from the first user input 62 and the metadata 50 of the media work 52. In a fifth variation, the step of selecting an effective preview of the media work is preferably based on the combination of one or more of the above variations.

The step of transmitting the selected preview 64 to the user preferably facilitates the viewing or listening (collectively the “experiencing”) of the preview by the user. The experiencing of the preview preferably entices the user to intelligently choose to download and/or purchase the media work 52. Preferably, the transmission of the selected preview 64 includes transmitting the selected preview 64 from a server 76 through a suitable medium 78, such as radio frequency waves, the Internet, a satellite system, a cable network, a landline or wireless telephone network, or any other suitable medium. If transmitted via a network, the transmission of the selected preview 64 preferably includes using an Internet protocol such as streaming, downloading, or a combination of streaming and downloading. The transmission of the selected preview 64 may, however, be transmitted from any suitable location/storage via a suitable medium.

As shown in FIG. 9, the method of the fourth embodiment preferably further includes accepting a second input 80 by the user for the transmission of a particular media work 52. The step of accepting a second input 80 from a user may be accomplished through the use of the input device 74, or any other suitable device. Preferably, a payment for these services would be required. Payment could be made by authentication as a member, authentication as a subscriber, direct payment, or some other combination or permutation of similar techniques. Alternatively, these services may be provided through alternative arrangements.

Preferably, the method of the fourth embodiment further includes transmitting the media work 52 to the user. The step of transmitting the media work 52 to the user preferably facilitates “experiencing” of the media work 52 by the user. Preferably, the transmission of the media work 52 includes transmitting the media work 52 from a server through a suitable medium, such as radio frequency waves, the Internet, a satellite system, a cable network, a landline or wireless telephone network, or any other suitable medium. If transmitted via a network, the transmission of the media work 52 preferably includes using an Internet protocol such as streaming, downloading, or a combination of streaming and downloading. Alternatively, the transmission of the media work 52 includes the shipping of a suitable device (such as a CD or DVD) to the user via a suitable postal service. The transmission of the media work 52 may, however, be transmitted from any suitable location/storage via a suitable medium.

Preferably, the transmission of the media work 52 includes transmission from a first source 82, while the transmission of the preview includes transmission from a second source 84. The first source 82 is preferably a media provider, such as a movie distributor, a television broadcaster, or any other suitable provider of media works. The second source 84, on the other hand, is preferably a web portal, such as Amazon or Yahoo!, that promotes the download and/or purchase of the media work 52. With this preferred arrangement, the method of the fourth embodiment preferably includes a transmission of a download and/or purchase request 86 from the second source 84 to the first source 82. The first source 82 and/or the second source 84 may alternatively include a decentralized or dispersed network (similar to the BitTorrent Network) or any other suitable entities.

Preferably, the transmission of the media work 52 includes the transmission of the media work 52 coded in a first format (such as DV or MPEG-4 for audio-video works) that is generally used in home theater systems (which typically include a receiver and 5+ speakers). This format, however, is not optimized for bandwidth-limited communications, such as communications through radio frequency waves, the Internet, or a landline or wireless telephone network. Thus, the transmission of the preview of the media work 52 preferably includes the transmission of the preview coded in a second format (such as .swf or .mp3) that is generally used in a computer system 66 on a network (such as the Internet). Alternatively, the transmission of the media work 52 and the transmission of the preview of the media work 52 may be similarly coded in either a first format (such as DV or MPEG-4 for audio-video works) that is generally used in home theater systems, or in a second format (such as .swf or .mp3) that is generally used in a computer system 66 on a network.

Preferably, the steps of transmitting the selected preview 64 and transmitting the media work 52 to the user respectively include sending the selected preview 64 and the media work 52 to an output device 88. The output device 88 preferably facilitates an experience of the media work 52 by the user. The output device 88 preferably includes a monitor, a speaker, a tactile device, any other suitable device, or any suitable combination of any permutation of suitable devices. Further, the output device 88 is preferably directly connected (either with or without wires) to the device or system 66 of the user. Alternatively, the output device 88 may include any suitable device that facilitates an experience of the media work 52 by the user and may be connected in any suitable manner to the device or system 66 of the user.

As a person skilled in the art will recognize from the previous detailed description and from the figures and claims, modifications and changes can be made to the preferred embodiments and variations of the invention without departing from the scope of the invention defined in the following claims.

We claim:

1. A method for selecting a preview of a media work that includes a first preview and a second preview, comprising:
providing metadata for the media work including a first entry that corresponds to the first preview and a second entry that corresponds to the second preview;
accepting a first input from a user;
selecting for the user a preview of the media work amongst the first preview and the second preview based on the first user input and the metadata; and
transmitting the selected preview to the user.

2. The method of claim 1 wherein the media work includes a moving picture.

3. The method of claim 2 wherein the first preview and the second preview both include a trailer for the moving picture.

4. The method of claim 2 wherein the first preview and the second preview both include a continuous video segment of the moving picture.

5. The method of claim 1 wherein the media work includes a song.

6. The method of claim 5 wherein the first preview and the second preview both include a continuous audio segment of the song.

7. The method of claim 1 wherein providing metadata for the media work includes providing metadata including a first entry and a second entry, wherein the first entry and the second entry belong to a media category.

8. The method of claim 7 wherein the media category is selected from the group consisting of actor name, character name, genre, keyword, and location.

9. The method of claim 7 wherein accepting a first input from a user includes accepting a first input for the media category.

10. The method of claim 9 wherein selecting a preview of the media work is further based on a comparison of the first user input for the media category and the first entry and the second entry within the media category.

11. The method of claim 1 wherein selecting a preview of the media work is further based on a comparison of a profile for the user and the metadata.

12. The method of claim 1 wherein transmitting the selected preview includes transmitting the selected preview via a network.

13. The method of claim 1 wherein transmitting the selected preview includes transmitting the selected preview using a protocol selected from the group consisting of streaming and downloading.

14. The method of claim 1 further comprising: accepting a second input by the user for the transmission of the media work.

15. The method of claim 14, wherein accepting a second input by the user for the transmission of the media work includes requiring at least one from the group consisting of: authentication as a member, authentication as a subscriber, and payment.

16. The method of claim 15 further comprising transmitting the media work.

17. The method of claim 16 wherein transmitting the media work includes transmitting the media work via a network.

18. The method of claim 16 wherein transmitting the media work includes transmitting the media work using a protocol selected from the group consisting of streaming and downloading.

19. The method of claim 16 wherein transmitting the media work includes transmitting from a first source, and wherein transmitting the selected preview to the user includes transmitting from a second source.

20. The method of claim 19, wherein transmitting the media work includes transmitting from a media provider.
